(19) United States
(12) Patent Application Publication
(10) Pub. No.: US 2008/0052700 A1
(43) Pub. Date: Feb. 28, 2008

(54) USB interface control panel on-line update method

(75) Inventors: Qianquan Han, Shenzhen (CN); Zhaoquan Liu, Shenzhen (CN); Jia Yao, Shenzhen (CN)

Correspondence Address: Leopold Presser;Scully, Scott, Murphy & Presser, 400 Garden City Plaza, Garden City, NY, 11530, US

(73) Assignee: Shenzhen Mindray Bio-Medical Electronics Co., Ltd., Shenzhen (CN)

(21) Appl. No.: 11/636,224

(22) Filed: Dec. 8, 2006

(30) Foreign Application Priority Data
Aug. 25, 2006 (CN) 200610062309.9

(51) Int. Cl. G06F 9/44

(52) U.S. Cl. 717/168

(57) ABSTRACT

The present invention relates to a USB interface control panel on-line update method, comprising steps of: the embedded soft-core processor, after receiving through USB module the on-line update command from the host computer, receiving update data sent from the host computer, and storing the update data into the volatile memory of the embedded soft-core processor; erasing the original embedded soft-core processor firmwares and/or FPGA configuration files stored in the non-volatile memory; writing the update data stored in the volatile memory into the non-volatile memory by means of programming. The present invention uses USB interface to realize the on-line updating of the control panel in the medical equipment and the like, wherein the control panel is capable of completely updating the embedded soft-core processor firmwares and/or FPGA hardware configuration files under the control of the host and without bringing interference to the normal operation by users.

### RELATED APPLICATION

The present application claims the priority of the Chinese Patent Application No. 200610062309.9, filed Jun. 25, 2006, titled “USB Interface Control Panel On-line Update Method”, which is incorporated herein by reference.

### FIELD OF THE INVENTION

The present invention relates to an on-line update method for updating the firmware of an electronic equipment, in particular, to an on-line update method for updating a USB Interface Control Panel.

### BACKGROUND OF THE INVENTION

Conventionally, most of the medical equipment control panels using a Micro Control Unit (MCU) architecture communicate with the host computer via RS232 serial port or PS/2. The MCU which supports In-Application Programming (IAP) functions can realize the MCU programme on-line update, but can not realize the on-line update for other programmable devices on the panel.

At present, most of the USB interface control panels in the medical equipment are assembled by various USB interface input devices such as keyboards that use commercial USB interface, and generally do not support on-line update function. The reasons therefor are obvious, for example, the personal Computer keyboard technique adopting common USB interface has been well developed, with little possibility of being updated, and therefore it is not necessary to provide the on-line update function. Accordingly, the disadvantage in prior art is that the on-line update function is not perfect.

There are currently some MCUs that are indeed capable of updating firmwares on line, the application of which improves the on-line update function of the control panel firmwares. Unfortunately, a greater difficulty is posed to the on-line updating of the Complex Programmable Logic Device (CPLD), and the realization thereof on MCU demands many resources.

### SUMMARY OF THE INVENTION

An object of the present invention is to provide a USB interface control panel on-line update method, wherein the USB interface control panel on-line update is executed through a USB interface, so as to realize on-line updating of embedded soft-core processor firmwares and FPGA configuration files through a USB interface.

To achieve this object, the present invention provides a USB interface control panel on-line update method, comprising steps of: A) an embedded soft-core processor, after receiving through a USB module an on-line update command from a host computer, obtaining update data (i.e. updated embedded soft-core processor firmwares and/or FPGA configuration files) sent from the host computer and storing the update data into a volatile memory of the embedded soft-core processor; B) erasing the original embedded soft-core processor firmwares and/or FPGA configuration files stored in a non-volatile memory; and C) writing the update data stored in the volatile memory into the non-volatile memory by means of programming.

In accordance with the USB interface control panel on-line update method of the present invention, after performing the step C, a system used for the control panel enters into the normal operating state; at this time, the system still executes the original embedded soft-core processor firmwares and/or FPGA configuration files.

In accordance with the USB interface control panel on-line update method of the present invention, in performing the step B, the embedded soft-core processor firmwares and/or FPGA configuration files in the non-volatile memory are selectively erased according to different on-line update commands; then the update data in the volatile memory is written into corresponding partitions of the non-volatile memory.

In accordance with the USB interface control panel on-line update method of the present invention, prior to performing the step A, the system, after being powered on, loads the FPGA configuration files into FPGA and loads the embedded soft-core processor firmwares into the volatile memory, then starts to execute an application program, which has the on-line update function.

In accordance with the USB interface control panel on-line update method of the present invention, after performing the step C, the host computer, through a USB interface in the USB module, sends a control panel reset command to reset the control panel, or the system is powered off and restarted, such that the system executes the updated embedded soft-core processor firmwares and/or FPGA configuration files.

By employing the above solutions, the present invention makes it possible to use a USB interface to realize the on-line updating of the control panel in the medical equipment and the like, so that the control panel is capable of completely updating the embedded soft-core processor firmwares and/or FPGA configuration files under the control of the host computer without any interference to the normal operation by users. The present invention is not only capable of updating the application program that controls the performance of CPU, but also capable of improving the capability of configuring the CPU and the corresponding external controllers thereof, that is, the present invention is capable of updating the CPU and the configurations of its external equipments, and altering various characteristics of the hardware of the CPU, as needed.

### BRIEF DESCRIPTION OF THE DRAWINGS

FIG. 1 is a schematic diagram showing the hardware circuit according to the present invention;

FIG. 2 is a schematic block diagram showing the control panel circuit principle according to the embodiment of the present invention;

FIG. 3 is a layout chart showing the control panel according to the embodiment of the present invention;

FIG. 4 is a state graph showing the ongoing on-line update;

FIG. 5 is a schematic diagram showing the memory space partition.

### DETAILED DESCRIPTION OF THE INVENTION

The present invention is now described in further details with reference to particular embodiments as well as the accompanying drawings.

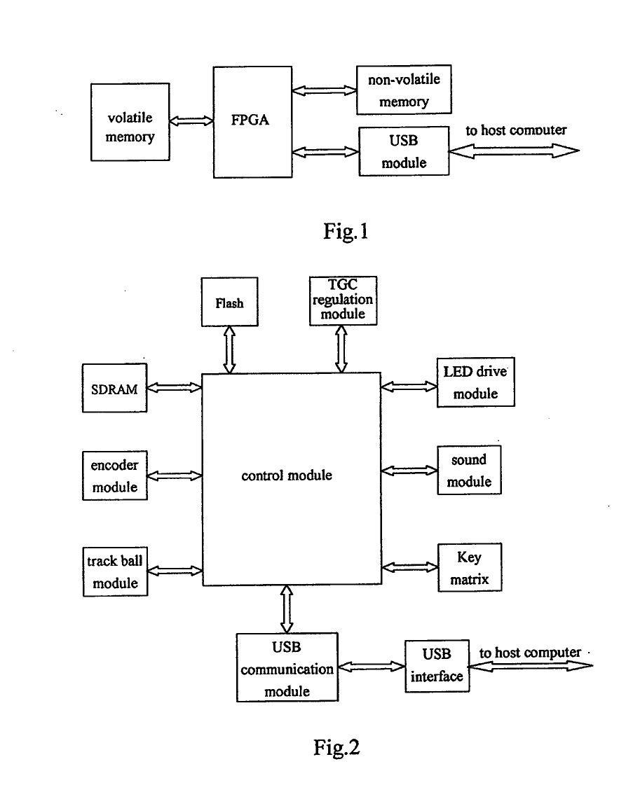

With reference to FIG. 1, the hardware construction according to the present invention generally includes FPGA, non-volatile memory, volatile memory and USB module. Wherein the FPGA as a core portion serves to realize the following logic circuits: SDRAM controller, embedded soft-core processor and other logic circuits; the non-volatile memory stores FPGA configuration files and the embedded soft-core processor firmwares, capable of long-term data preservation even in the case of power-failure; the volatile memory is used as a memory space in the embedded soft-core processor, wherein the firmwares of the embedded soft-core processor is executed after being loaded into the volatile memory, so as to enhance the execution efficiency of the embedded soft-core processor; the USB module is used to bridge the FPGA and the host computer to carry out data exchange.

What is shown in FIG. 2 is a block diagram of the control panel circuit suitable for use in the control panel in the ultrasonic medical diagnostic system, comprising: a control module, a key matrix, a sound module, a LED drive module, a TGC regulation module, a non-volatile memory, a volatile memory, an encoder module, a track ball module, a USB communication module and a USB interface. The control module uses FPGA to realize the following logic circuits: a SDRAM controller, an embedded soft-core processor and other logic circuits. The non-volatile memory, i.e. Flash, stores the soft-core processor program and the FPGA logic design data. When the control panel is powered on, FPGA automatically reads the configuration data from this Flash to complete the FPGA's configuration. Upon completion of the FPGA configuration, the PC (Program counter) pointer of the soft-core processor points to Boot Rom, then the data stored in the Flash is copied into the volatile memory SDRAM. After completing this copy process, the PC pointer of the soft-core processor points to the SDRAM so as to execute the entire application program, whereby the control panel subsequently begins to operate normally.

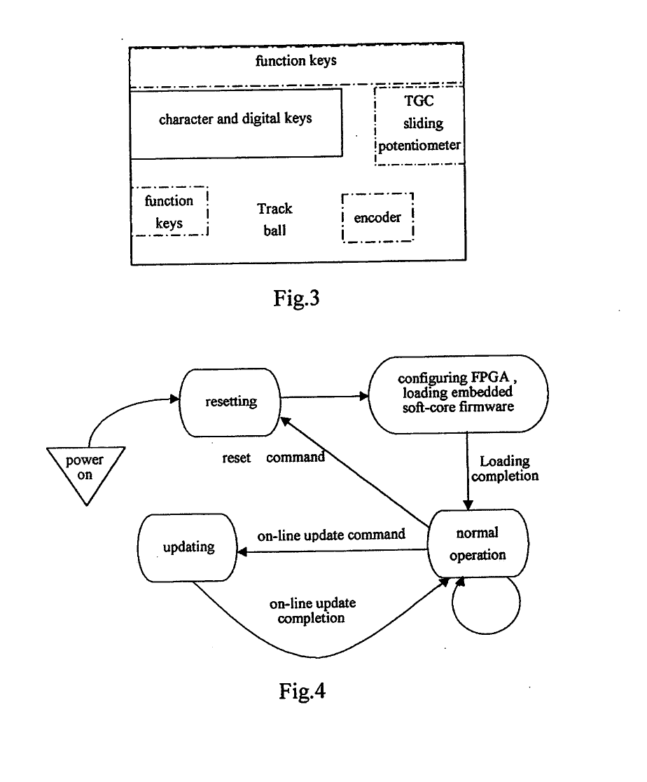

With reference to FIG. 3, a layout chart showing the control panel of an ultrasonic medical diagnostic system is illustrated. To assure that each of the functions can be realized with a physical USB interface, the control panel is divided into the following three sections: the first section is character and digital keys; the second section is the track ball section; and the third section comprises various dedicated modules used by the ultrasonic diagnostic equipment, including various function keys, adjustment knobs, a TGC sliding potentiometer and various LEDs indicating signals, etc. The key backlight LEDs are distributed around all the keys and encoders, and thus are not shown in FIG. 3.

With reference to FIG. 4, the process for realizing control panel on-line update is illustrated, which comprises the following steps:

(1) The system enters into the reset state after being powered on.

(2) Upon invalidation of reset signal, the system loads the FPGA configuration files into FPGA, and loads the embedded soft-core processor firmwares into SDRAM.

(3) After completing this loading, the embedded soft-core processor starts to execute the application program, and enters into the normal operating state; the application program has the on-line update function.

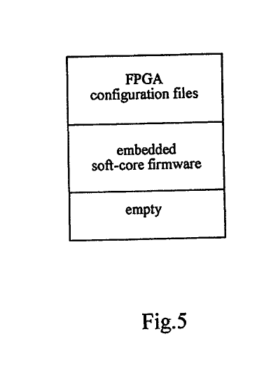

(4) Upon receipt of an update command, the embedded soft-core processor enters into the update state, and simultaneously receives the update date and stores it into SDRAM for buffering. According to different update commands, the embedded soft-core processor firmwares and/or FPGA configuration files in the non-volatile memory are selectively erased. Subsequently, the new data in the SDRAM is written into the corresponding partitions of the non-volatile memory. The memory space partition is illustrated in FIG. 5.

(5) Upon the update completion, the system again enters into the normal operating state. At this time, the system still executes the original embedded soft-core processor firmwares and/or FPGA configuration files.

(6) The host computer sends, through the USB interface, control panel reset command to reset the control panel once again, or the system is powered off and restarted, such that step (2) is started, and the system executes new embedded soft-core processor firmwares and/or FPGA configuration files.

After step (6), the system again enters into the normal operating state and executes the updated embedded soft-core processor firmwares and/or FPGA configuration files. At this time, the layout of the control panel, all the functional modules, key positions, and key definition are updated according to the new soft-core processor firmwares and/or FPGA configuration files, so as to complete the control panel on-line update.

The bridging device according to the present invention may be replaced, for example, with a serial port bridging device, in order to achieve the on-line update through serial port.

The volatile memory in the present invention includes, but not limited to a SDRAM, and the non-volatile memory includes, but not limited to a Flash.

The present invention is hereinabove described by particular examples, which are illustrative only and are not intended to limit the present invention. Those skilled in the art may understand that, according to the teachings of the present invention, the steps of the method according to the present invention may be varied. Therefore, various modifications, changes, variations, and other equivalent substitutions, without departing from the spirits and scopes of the present invention, are intended to be covered by the appended claims.

What is claimed is:

1. A USB interface control panel on-line update method, comprising steps of:
A) an embedded soft-core processor, after receiving through a USB module an on-line update command from a host computer, obtaining update data sent from the host computer and storing the update data into a volatile memory of the embedded soft-core processor;
B) erasing the original embedded soft-core processor firmwares and/or FPGA configuration files stored in a non-volatile memory; and
C) writing the update data stored in the volatile memory into the non-volatile memory by means of programming.

2. The on-line update method of claim 1, wherein after performing the step C, a system used for the control panel enters into the normal operating state; at this time, the system still executes the original embedded soft-core processor firmwares and/or FPGA configuration files.

3. The on-line update method of claim 1, wherein in performing the step B, the embedded soft-core processor firmwares and/or FPGA configuration files in the non-volatile memory are selectively erased according to different on-line update commands; then the update data in the volatile memory is written into corresponding partitions of the non-volatile memory.

4. The on-line update method of claim 1, wherein prior to performing the step A, the system, after being powered on, loads the original FPGA configuration files into FPGA and loads the original embedded soft-core processor firmwares into the volatile memory, then starts to execute an application program, which has the on-line update function.

5. The on-line update method of claim 1, wherein after performing the step C, the host computer, through a USB interface in the USB module, sends a control panel reset command to reset the control panel, or the system is powered off and restarted, such that the system executes the updated embedded soft-core processor firmwares and/or FPGA configuration files.

6. The on-line update method of claim 1, wherein after performing said step C, the host computer, through the USB interface, sends a control panel reset command to reset the control panel, or the system is powered off and restarted, such that the system executes the updated embedded soft-core processor firmwares and/or FPGA configuration files.

7. The on-line update method of claim 3, wherein after performing the step C, the host computer, through a USB interface, sends a control panel reset command to reset the control pane, or the system is powered off and restarted, such that the system executes the updated embedded soft-core processor firmwares and/or FPGA configuration files.

8. The on-line update method of claim 4, wherein after performing the step C, the host computer, through a USB interface, sends a control panel reset command to reset the control panel, or the system is powered off and restarted, such that the system executes the updated embedded soft-core processor firmwares and/or FPGA configuration files.
